(19) United States
(12) Patent Application Publication
(10) Pub. No.: US 2022/0165150 A1
(43) Pub. Date: May 26, 2022

(54) SYSTEM AND METHOD FOR DETERMINING DYNAMIC ROAD CAPACITY DATA FOR TRAFFIC CONDITION

(71) Applicant: HERE Global B.V., Eindhoven (NL)

(72) Inventors: Jingwei XU, Chicago, IL (US); Bruce BERNHARDT, Chicago, IL (US); Weimin HUANG, Chicago, IL (US); Yuxin GUAN, Chicago, IL (US)

(21) Appl. No.: 17/103,438

(22) Filed: Nov. 24, 2020

(51) Int. Cl. G08G 1/01

(52) U.S. Cl. CPC G08G 1/0129; G08G 1/0145; G08G 1/0133; G08G 1/0112

(57) ABSTRACT

A system, a method, and a computer program product may be provided for determining dynamic road capacity data of one or more lanes of a road segment in a region. A system may include a memory configured to store computer program code and a processor configured to execute the computer program code to obtain probe data, historical capacity dynamic pattern data and event data. The processor may be configured to calculate road capacity data of the lane. The processor may be configured to calculate a count of movable objects in the lane. The processor may be configured to determine a traffic condition of the lane. The processor may be configured to determine the dynamic road capacity data based on the road capacity data, the count of one or more movable objects, the historical capacity dynamic pattern data and the traffic condition of the at least one lane of the road segment.

### TECHNOLOGICAL FIELD

The present disclosure generally relates to routing and navigation systems, and more particularly relates to determining dynamic road capacity data of one or more lanes associated with a road segment in a region.

### BACKGROUND

Autonomous driving has been an emerging technology area in recent years. An autonomous vehicle may use different sensor technologies, High Definition (HD) maps, and dynamic backend content including traffic information services to reach a right decision strategy to drive along the road in a road network. In most scenarios, the vehicles would be driverless or fully non-human involved vehicles.

Traffic conditions play a critical role in the autonomous driving scenarios. Traffic congestion, one of the traffic conditions, often means stopped or stop-and-go traffic, where vehicle speeds are slower and sometimes much slower as compared to normal or free flow speeds. A traffic congestion and/or jam may occur and vehicles start accumulating as a result of traffic volume exceeding an available road capacity. The traffic congestion may be caused by various reasons, such as, but not limited to, bad weather like heavy snow or fog, and sports events in a nearby region. The traffic congestion may hamper vehicles, for example by prolonging travel time, by increasing a likelihood of collisions, or by forcing drivers or autonomous vehicles onto unfamiliar or undesirable travel routes. Consequently, dangerous queuing situations may result in bottlenecks or hazardous situations like significant crashes.

In certain scenarios, the road capacity may be increased by switching a direction of lanes, opening or closing expressing lanes, and modifying a number of lanes to add extra driving lanes, such as allowing for temporary driving on a road shoulder. Many a times, such increase in the road capacity may be unhelpful to reduce the situation of traffic jam or congestion when the traffic volume starts accumulating because the transportation infrastructure may be unable to change significantly. For example, adding more driving lanes seems implausible from economic perspective beyond temporary expansion to the road shoulder.

Accordingly, there is a need for a reliable system for safety reasons to identify data associated with dynamic traffic change and road capacity for an autonomous vehicle status change update so that it is beneficial for a driver of the autonomous vehicle, a customer or agencies.

### BRIEF SUMMARY

A system, a method, and a computer program product are provided herein that focuses on determining dynamic road capacity data. In one aspect, the system for determining the dynamic road capacity data of at least one lane of a road segment may be provided. The system may include at least one non-transitory memory configured to store computer program code; and at least one processor (hereinafter referred as processor) configured to execute the computer program code to obtain a set of input data comprising at least probe data and historical capacity dynamic pattern data associated with the at least one lane of the road segment. The processor may be configured to calculate road capacity data of the at least one lane of the road segment, based on the probe data and one or more map attributes. According to some example embodiments, the processor may be configured to calculate a count of one or more movable objects in the at least one lane of the road segment, based on the probe data. In accordance with an embodiment, the processor may be configured to determine a traffic condition of the at least one lane of the road segment, based on the probe data. According to an example embodiment, the processor may be further configured to determine dynamic road capacity data based on the road capacity data, the count of the one or more movable objects, the historical capacity dynamic pattern data and the traffic condition of the at least one lane of the road segment. In accordance with an embodiment, the traffic condition indicates a congestion state or a non-congestion state.

According to some example embodiments, the processor may be further configured to calculate a time for the at least one lane of the road segment to reach the congestion state from the non-congestion state.

According to some example embodiments, the processor may be configured to calculate a time, wherein the time is calculated as:

$$t = \frac{n - m}{x - y}$$

and wherein t is time taken for the one or more movable objects to reach the congestion state from the non-congestion state,
wherein n is congestion capacity threshold for the at least one lane of the road segment,
wherein m is current count of one or more movable objects on the at least one lane of the road segment,
wherein n>m;
wherein x is incoming count of one or more movable objects on the at least one lane of the road segment per certain time period, and
wherein y is outgoing count of one or more movable objects on the at least one lane of the road segment per certain time period.

According to some example embodiments, the processor may be configured to calculate a current deficit of the count of one or more movable objects accommodated in the at least one lane of the road segment to reach the congestion state from the non-congestion state.

According to some example embodiments, the processor may be configured to obtain event data associated with the at least one lane of the road segment of the region and calculate incoming lane capacity data and outgoing lane capacity data associated with the road segment based on the probe data and the event data. In accordance with an embodiment, the event data include but not limited to weather data, holiday data, and music festivals data. In accordance with an embodiment, the determined traffic condition is further based on the event data.

According to some example embodiments, wherein to determine a traffic condition of the at least one road segment, the processor is further configured to calculate a ratio between the count of the one or more movable objects and the road capacity.

In accordance with an embodiment, wherein to determine the dynamic road capacity data, the processor is further configured to retrieve historical capacity dynamic pattern data for the at least one lane of the road segment and generate a traffic pattern profile based on the historical capacity dynamic pattern data, the count of one or more movable objects and the traffic condition of the at least one lane of the road segment.

According to some example embodiments, the processor may be configured to transmit a report of the dynamic road capacity data to a backend server.

According to some example embodiments, the processor may be configured to obtain map data of the region and update the map data of the region based on the report of the dynamic road capacity data.

According to some example embodiments, the processor may be configured to transmit congestion risk warning message to one or more end user vehicles in the at least one road segment based on the updated map data.

According to some example embodiments, the processor may be configured to recommend driving strategies to one or more vehicles driving upstream of the at least one lane of the road segment based on the updated map data.

According to some example embodiments, the map attributes include upstream road segment data for an upstream road segment connected to the at least one road segment and downstream road segment data for a downstream road segment connected to the at least one road segment.

According to some example embodiments, the processor may be configured to map-match the probe data to the at least one lane of the road segment.

Embodiments disclosed herein may provide a method for determining dynamic road capacity data for at least a lane of a road segment in a region. The method may include obtaining, by one or more processors, a set of input data comprising at least probe data and historical capacity dynamic pattern data associated with at least one lane of a road segment; calculating, by one or more processors, a road capacity data of the at least one lane of the road segment, based on the probe data and one or more map attributes; calculating, by one or more processors, a count of one or more movable objects in the at least one lane of the road segment, based on the probe data; determining, by one or more processors, a traffic condition of the at least one lane of the road segment, based on the probe data; and determining, by one or more processors, dynamic road capacity data based on the road capacity data, the count of the one or more movable objects, historical capacity dynamic pattern data and the traffic condition of the at least one lane of the road segment.

Embodiments of the present disclosure may provide a computer programmable product including at least one non-transitory computer-readable storage medium having computer-executable program code stored therein. The computer programmable product comprising a non-transitory computer readable medium having stored thereon computer executable instructions, which when executed by a computer, cause the computer to carry out operations, for determining dynamic road capacity data for at least a lane of a road segment in a region, the operations comprising: obtaining, by one or more processors, a set of input data comprising at least probe data and historical capacity dynamic pattern data associated with at least one lane of a road segment; calculating, by one or more processors, a road capacity data of the at least one lane of the road segment, based on the probe data and one or more map attributes; calculating, by one or more processors, a count of one or more movable objects in the at least one lane of the road segment, based on the probe data; determining, by one or more processors, a traffic condition of the at least one lane of the road segment, based on the probe data; and determining, by one or more processors, dynamic road capacity data based on the road capacity data, the count of the one or more movable objects, the historical capacity dynamic pattern data and the traffic condition of the at least one lane of the road segment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a block diagram that illustrates a network environment of a system implemented for determining dynamic road capacity data associated with at least a lane of a road segment, in accordance with an example embodiment;

FIG. 2 illustrates a block diagram of the system, exemplarily illustrated in FIG. 1, that may be used for determining dynamic road capacity data associated with at least a lane of a road segment, in accordance with an example embodiment;

FIG. 3 illustrates a block diagram of a generic vehicular system to elaborate on a problem of traffic congestion on one or more lanes of a road segment, in accordance with an example embodiment;

FIG. 4 exemplarily illustrates a schematic diagram for an exemplary scenario used by the system for three road segments with different number of probe vehicles corresponding to different traffic conditions, in accordance with an example embodiment;

FIG. 5 exemplarily illustrates a schematic diagram for an exemplary scenario to generate, by a system, traffic pattern profile corresponding to traffic conditions, in accordance with an example embodiment;

FIG. 6 exemplarily illustrates a schematic diagram for an exemplary scenario to determine, by a system, dynamic road capacity data corresponding to traffic conditions using upstreaming road segment and down streaming road segment on a lane level capacity connection, in accordance with an example embodiment; and

FIG. 7 illustrates a flowchart 700 for implementation of an exemplary method to determine dynamic road capacity data of a lane of a road segment in a region, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “lane” may refer to a part of a road that is designated for travel of vehicles or pedestrians as per some condition.

The term “link” may refer to any connecting pathway including, but not limited, to a roadway, a highway, a freeway, an expressway, a lane, a street path, a road, an alley, a controlled access roadway, a free access roadway and the like.

The term “route” may refer to a path from a source location to a destination location on any link.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

### End of Definitions

A system, a method, and a computer program product are provided herein in accordance with an example embodiment for determining dynamic road capacity data of at least one road segment in a region. The system, the method, and the computer program product disclosed herein provide accurate and precise road capacity data for providing high quality navigation assistance, especially in autonomous driving in near real time. The system, the method, and the computer program product disclosed herein facilitate safety issues and alert drivers to traffic conditions or driving conditions in a timely and targeted way in advance. The system, the method, and the computer program product disclosed herein may further provide support to government agencies to identify problem locations (or congested locations) in near real time to help in better decision making and for taking action quickly to avoid the road safety risks.

The system, the method, and the computer program product disclosed herein may be configured to determine when and where a road capacity of a road segment may approach towards congestion threshold based on probe data and event data to further avoid or minimize congestion areas and traffic jams by rerouting vehicles to alternate paths or enable/disable the use of an additional lane.

The system, the method, and the computer program product disclosed herein may be configured to generate a traffic pattern profile based on historical capacity dynamic pattern data. The system, the method, and the computer program product disclosed herein may further provide a notification message indicating a degree of congestion on a road segment of a region. For example, the notification message may inform a vehicle or user equipment with up-to-date data for the region. Alternatively, the available up-to-date data may be pushed as an update to the vehicle or user equipment. These and other technical improvements of the present disclosure will become evident from the description provided herein.

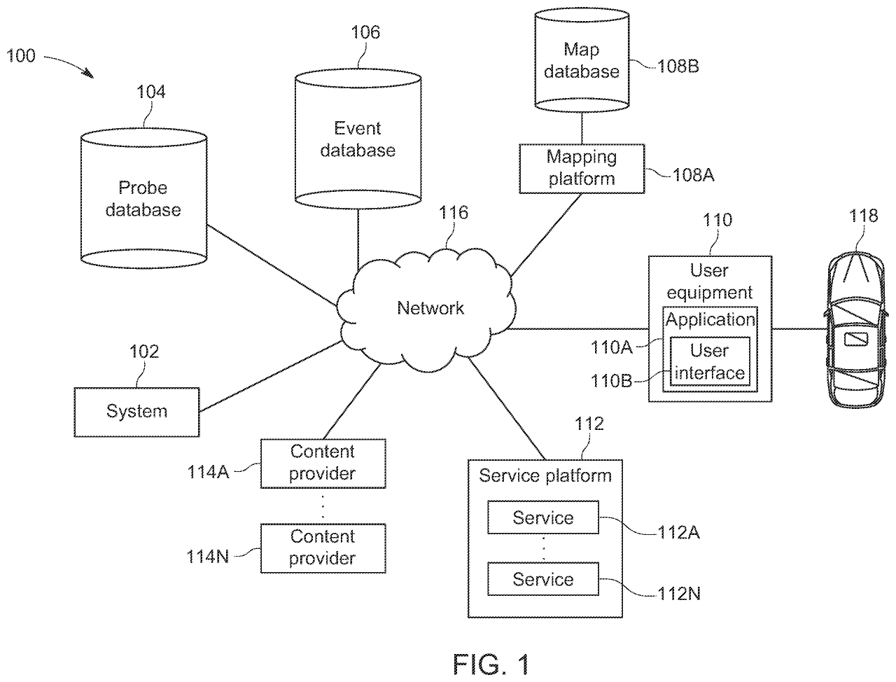

FIG. 1 is a block diagram 100 that illustrates a network environment of operation of a system for determining dynamic road capacity data associated with at least a lane of a road segment in a region, in accordance with an example embodiment.

There is shown a network environment 100 that may include a system 102, a probe database 104, an event database 106, a mapping platform 108A, a map database 108B, a user equipment (UE) 110, an application 110A, a user interface (UI) 110B, a services platform 112 with a plurality of services 112A . . . 112N, a plurality of content providers 114A . . . 114N and a network 116. There is further shown one or more vehicles, such as a vehicle 118 on a road segment in a region. The UE 110 may include the application 110A and the user interface 110B. The system 102 may be communicatively coupled to the UE 110, via the network 116. Also, the system 102 may be communicatively coupled to the services platform 112 and the plurality of content providers 114A . . . 114N, via the network 116.

In some example embodiments, the system 102 may be implemented in a cloud computing environment. In some other example embodiments, the system 102 may be implemented in the vehicle 118. In accordance with an embodiment, the probe database 104 may communicate directly with the map database 108B. In accordance with an embodiment, the system 102 may communicate directly with the probe database 104 and the event database 106. In accordance with an embodiment, the event database 106 may communicate directly with the map database 108B. In accordance with another embodiment, the probe database 104, the event database 106 and the map database 108B may be a part of the mapping platform 108A. All the components in the network environment 100 may be coupled directly or indirectly to the network 116. The components described in the network environment 100 may be further broken down into more than one component and/or combined together in any suitable arrangement. Further, one or more components may be rearranged, changed, added, and/or removed.

The system 102 may comprise suitable logic, circuitry, and interfaces that may be configured for determining dynamic road capacity data for at least a lane (hereinafter referred as a lane) of a road segment in a region. Further, the system 102 may be configured to calculate a road capacity of the lane of the road segment based on one or more road segment attributes associated with the lane of the road segment. The system may be configured to calculate a count of one or more movable objects in the lane of the road segment based on probe data. The system 102 may be configured to determine a traffic condition of the lane, based on the probe data. The system 102 may be configured to determine the dynamic road capacity data, based on the count of the one or more movable objects, the traffic condition and the road capacity of the lane of the road segment. Additionally or alternatively, the system 102 may be configured to receive geo-coordinates of the region from map data stored in the map database 108B.

The probe database 104 may comprise suitable logic, circuitry, and interfaces that may be configured to store probe data, which may be collected, for example, from one or more movable objects (such as, vehicles) traveling along a road network or within a venue. The probe data may be gathered and fused to infer an accurate map of an environment in which probes or fleeting cars are moving. In accordance with an embodiment, such probe data may be updated in real time or near real time such as on an hourly basis, to provide accurate and up to date probe data. The probe data may be collected from any sensor that may inform a probe database 104 of features within an environment that are appropriate for traffic related services. In accordance with an embodiment, the probe data may be collected from any sensor that may inform a map database 108B of features within an environment that are appropriate for mapping. For example, motion sensors, inertia sensors, image capture sensors, proximity sensors, LIDAR (light detection and ranging) sensors, GPS sensors, and ultrasonic sensors may be used to collect the probe data. The gathering of large quantities of crowd-sourced data may facilitate the accurate modeling and mapping of an environment, whether it is a lane of a road segment or the interior of a multi-level parking structure.

In accordance with an embodiment, the probe data (such as, floating car data) may be collected from consumer vehicles travelling on the lane of the road segment throughout a geographic region (or region). In accordance with an embodiment, a map developer may employ field personnel to travel by a vehicle along roads throughout the region to observe features and/or record information. The map developers may crowdsource geographic map data (or map data), vehicle probe data (or probe data), and event data to generate, substantiate, or update the map data.

The probe data may be used to determine traffic volume associated with movement of one or more movable objects along the road segment in a region. In accordance with an embodiment, the traffic volume may be determined for all road segments in a region. The traffic volume on the lane of the road segment may correspond to one or more movable objects on the lane of the road segment for a given time period. The probe count from the probe data may be observed within the given time period and projected to determine the traffic volume for that given time period. In accordance with an embodiment, the probe database 104 may be configured to store and transmit probe data including positional, speed, and temporal data.

The event database 106 may comprise suitable logic, circuitry, and interfaces that may be configured to store the event data associated with the lane of the road segment in the region. In accordance with an embodiment, the event data from the event database 106 may be used by the system 102 to determine the traffic condition on the lane of the road segment. In accordance with an embodiment, the event data from the event database 106 may be used by the system 102 to adjust calculation of the count of the one or more movable objects that is based on the probe data for determination of the dynamic road capacity data. The probe data taken over a long period of time (e.g. months) may be diverse enough to smooth out any outlier events that would adversely affect probe distribution of the probe data. Events, however, may also be excluded or included as a weight when generating the probe distribution from the probe data.

The events may also be taken into consideration when the system 102 calculates or estimates current traffic volume for the lane of the road segment in the region. For example, a sports event may cause increased traffic volume over the expected normal traffic volume. The increased traffic volume may be determined based on previously observed and recorded events. In accordance with an embodiment, the determined traffic volume may also be calibrated based on a recent (during the event) snapshot of probe vehicles on a roadway network.

The event data from the event database 106 may also be supplemented with additional ground truth data acquired from roadside sensors. Advanced planning and coordination for increased traffic volume may allow agencies to develop and deploy optimal operational strategies, traffic control plans, protocols, procedures, and technologies needed to control traffic and share real time or near real time information with other stakeholders on the day of an event. Such capabilities may allow agencies to proactively manage and control traffic to accommodate the increased travel demand generated by the event and use the available road segment capacity in the most efficient and effective manner. The event database 106 may be configured to store the event data about changes in traffic situation registered by GPS provider(s), such as, but not limited to, incidents, road repairs, heavy rains, snow, fog, holiday or other events which may have influence on the road capacity of the lane of the road segment in the region.

The mapping platform 108A may comprise suitable logic, circuitry, and interfaces that may be configured to store one or more map attributes associated with the one or more lanes of the road segment in the region. The mapping platform 108A may be configured to update the map data, in the map database 108B, associated with the dynamic road capacity data. The mapping platform 108A may include techniques related to geocoding, routing (multimodal, intermodal, and unimodal), clustering algorithms, machine learning in location based solutions, natural language processing algorithms, artificial intelligence algorithms, and the like. Data for different modules of the mapping platform 108A may be collected using a plurality of technologies including, but not limited to drones, sensors, connected cars, cameras, probes, chipsets and the like. In some embodiments, the mapping platform 108A may be embodied as a chip or chip set. In other words, the mapping platform 108A may comprise one or more physical packages (such as, chips) that includes materials, components and/or wires on a structural assembly (such as, a baseboard).

The map database 108B may comprise suitable logic, circuitry, and interfaces that may be configured to store the dynamic road capacity data of the lane of the road segment in the region. The map database 108B may be configured to store data associated with the traffic condition of the lane of the road segment in the region. The data may also include cartographic data, routing data, and maneuvering data. The data may also include, but not limited to, location of intersections, diversions to be caused due to the heavy congestion, suggested routes to avoid heavy congestion to be caused due to the congestion. In accordance with an embodiment, the map database 108B may be configured to receive the data related to the traffic conditions in the region for a road network from external systems, such as, one or more of background batch data services, streaming data services and third party service providers, via the network 116.

In some embodiments, the map database 108B may be a part of the mapping platform 108A. The map database 108B may be a master map database stored in a format that facilitates updating, maintenance, and development. For example, the master map database or data in the master map database may be in an Oracle spatial format or other spatial format, such as, for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

In addition, the map database 108B may include the event data (such as, but not limited to, traffic incidents, construction activities, scheduled events, and unscheduled events) associated with Point of Interest (POI) data records or other records of the map database 108B associated with the system 102.

For example, geographic data may be compiled (such as into a platform specification format (PSF)) to organize and/or configure the data for performing navigation-related functions and/or services, such as route calculation, route guidance, map display, speed calculation, distance and travel time functions, and other functions, by a navigation device, such as the UE 110. The navigation-related functions may correspond to vehicle navigation, pedestrian navigation, navigation to a favored parking spot or other types of navigation. While example embodiments described herein generally relate to vehicular travel and parking along roads, example embodiments may be implemented for bicycle travel along bike paths and bike rack/parking availability, boat travel along maritime navigational routes including dock or boat slip availability, etc. The compilation to produce the end user databases may be performed by a party or entity separate from the map developer. For example, a customer of the map developer, such as a navigation device developer or other end user device developer, may perform compilation on a received map database 108B in a delivery format to produce one or more compiled navigation databases.

In some embodiments, the map database 108B may be a master geographic database configured on the side of the system 102. In accordance with an embodiment, a client-side map database may represent a compiled navigation database that may be used in or with end user devices (e.g., the UE 110) to provide navigation based on the dynamic road capacity data, the traffic conditions, speed adjustment, and/or map-related functions to navigate through the lane of the road segment in the region.

Optionally, the map database 108B may contain lane segment and node data records or other data that may represent the road segment in the region, pedestrian lane or areas in addition to or instead of the vehicle road record data. The road segments and nodes may be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, and parks. The map database 108B may additionally include data about places, such as cities, towns, or other communities, and other geographic features such as bodies of water, mountain ranges, etc.

The UE 110 may comprise suitable logic, circuitry, and interfaces that may be configured to provide navigation assistance to vehicles, such as, the vehicle 118 among other services. In accordance with an embodiment, the UE 110 may be configured to provide navigation and map functions (such as, guidance and map display) along with the traffic conditions of a route for an end user (not shown in the FIG. 1). The traffic conditions may indicate a degree of congestion in each lane. In accordance with an embodiment, the degree of congestion may correspond to one of a heavy congestion, a mild congestion (or queueing) and a light congestion or free flow on the road segment. In accordance with an embodiment, the UE 110 may be configured to transmit congestion risk warning message to the vehicle 118, based on the dynamic road capacity data. The dynamic road capacity data may be updated in the map data of the map database 108B. In accordance with an embodiment, the UE 110 may be configured to notify the vehicle 118 with driving strategies to drive upstream of the lane of the road segment. In accordance with an embodiment, the vehicle 118 associated with the UE 110 may correspond to an autonomous vehicle or a manually driven vehicle. An autonomous vehicle, as used throughout the disclosure, may refer to a vehicle which has autonomous driving capabilities at least in some conditions. For example, the autonomous vehicle may exhibit autonomous driving on streets and roads having physical dividers between driving lanes, a road segment having one or more incoming and outgoing lanes. The UE 110 may be a part of the vehicle 118. The UE 110 may be installed in the vehicle 118. In accordance with an embodiment, the UE 110 may be the vehicle itself.

The UE 110 may include the application 110A with the user interface 110B. In accordance with an embodiment, the UE 110 may be an in-vehicle navigation system, such as, an infotainment system, a personal navigation device (PND), a portable navigation device, a cellular telephone, a smart phone, a personal digital assistant (PDA), a watch, a camera, a computer, a workstation, and other device that may perform navigation-related functions (such as digital routing and map display). Examples of the UE 110 may include, but is not limited to, a mobile computing device (such as a laptop computer, tablet computer, mobile phone and smart phone), navigation unit, personal data assistant, watch, and camera. Additionally or alternatively, the UE 110 may be a fixed computing device, such as a personal computer, computer workstation, kiosk, office terminal computer or a system.

In accordance with an embodiment, the UE 110 may be an in-vehicle navigation system for navigation and map functions (such as, guidance and map display). The UE 110 may include the application 110A with the user interface 110B to access one or more map and navigation related functions that may include traffic condition notification rendered by the system 102. In other words, the UE 110 may include the application 110A with the user interface 110B. The user interface 110B may be configured to enable the end user associated with the UE 110 to access the system 102. In accordance with an embodiment, the UE 110 may be accessible to the system 102 via the network 116.

The services platform 112 may provide a plurality of services (such as, navigation related functions and services) 112A . . . 112N to the application 110A running on the UE 110. The services 112A . . . 112N may include navigation functions, speed adjustment functions, traffic condition related updates, weather related updates, warnings and alerts, parking related services and indoor mapping services. In accordance with an embodiment, the services 112A . . . 112N may be provided by the plurality of content providers 114A . . . 114N. In some examples, the plurality of content providers 114A . . . 114N may access various Software Development Kits (SDKs) from the services platform 112 for implementation of one or more services 112A . . . 112N. In accordance with an embodiment, the services platform 112 and the system 102 may be integrated into a single platform to provide a suite of mapping and navigation related applications for Original Equipment Manufacturer (OEM) devices, such as the UE 110. The UE 110 may be configured to interface with the services platform 112, the plurality of content provider 114A . . . 114N, and the system 102 over the network 116. Thus, the system 102 and the services platform 112 may enable provision of cloud-based services for the UE 110, such as, storing the data related to the traffic conditions in the OEM cloud in batches or in real-time and retrieving the stored data for generating notifications associated with the traffic conditions.

The plurality of content providers 114A . . . 114N may be configured to maintain data stored in the probe database 104, the event database 106, and the map database 108B. In accordance with an embodiment, the plurality of content providers 114A . . . 114N may correspond to map developers which collect geographic data to generate and enhance the map database 108B. In accordance with an embodiment, the map developers may obtain data from other sources, such as municipalities, third party traffic data providers or respective geographic authorities. In accordance with an embodiment, the map developers may collect data (such as, floating car data) from consumer vehicles travelling on the road segment throughout the geographic region. In accordance with an embodiment, the map developer may employ field personnel to travel by a vehicle along roads throughout the geographic region to observe features and/or record information. The map developers may crowdsource the probe data and the event data to generate, substantiate, or update map data.

The network 116 may comprise suitable logic, circuitry, and interfaces that may be configured to provide a plurality of network ports and a plurality of communication channels for transmission and reception of data, such as data from the probe database 104, the event database 106 and the map database 108B. Each network port may correspond to a virtual address (or a physical machine address) for transmission and reception of communication data. For example, the virtual address may be an Internet Protocol Version 4 (IPv4) (or an IPv6 address) and the physical address may be a Media Access Control (MAC) address. The network 116 may include a medium through which the system 102, and/or the other components may communicate with each other. The network 116 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 116 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) network, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

In operation, the system 102 may be configured to obtain a set of input data comprising at least the probe data associated with the lane of the road segment in the region. The system 102 may be configured to map match the probe data to at least a lane of the road segment. In accordance with an embodiment, the region may be determined by the system 102 in response to a request from the end user. In accordance with another embodiment, the determination of the region may also be initiated autonomously by the system 102. The region may be of any size or shape, such as, a rectangle, a circle, a trapezoidal, a square, a triangle, and a parallelogram. The probe data may be classified as current probe data and historical probe data. The historical probe data may include historical capacity dynamic pattern data.

In accordance with an embodiment, the system 102 may be configured to obtain the event data associated with the lane of the road segment. The road segment may include two or more lanes. In accordance with an embodiment, the system 102 may be configured to calculate a count of one or more movable objects on the lane of the road segment, based on the probe data. The one or more movable objects (hereinafter referred as movable objects) may include, but not limited to, a bus, a taxi, a vehicle, and a parking vehicle. In accordance with another embodiment, the movable objects may include pedestrians. In accordance with an embodiment, any machine learning technique (such as, deep machine learning technique) may be used to identify movable objects on the lane of the road segment in the region.

The system 102 may be configured to calculate the road capacity data for the lane of the road segment, based on one or more road segment attributes (or map attributes) associated with the road segment obtained from the map data. The road capacity data may be expressed as a maximum number of vehicles, passengers or the like on the lane of the road segment of a road that can pass a given point in unit time. In accordance with an embodiment, the unit time may usually be an hour, i.e., vehicles per hour per lane. The road capacity data may determine that how much traffic a given transportation facility can accommodate. The road capacity data may express physical count of vehicles and passengers a lane of the road segment can afford.

The road capacity data for movable objects may depend on various map free flow or speed limit attributes of the road segment, such as functional class of lanes of the road segment, geometry information of the road segment. Functional class is a road type indicator, reflecting traffic speed and volume, as well as the importance and connectivity of the road. The functional class may be defined by following types: Type 1: a road with high volume, maximum speed traffic; Type 2: a road with high volume, high speed traffic; Type 3: a road with high volume traffic; Type 4: a road with high volume traffic at moderate speeds between neighborhoods; and Type 5: a road whose volume and traffic flow are below the level of any other functional class. Further, in general three basic types of roads and streets may be identified in the functional classification process: arterials, collectors, and locals. Arterials are expected to provide direct routings for large volumes of traffic traveling long distances at high operating speeds. Collector roads may serve a dual function as they provide some degree of mobility and they also serve abutting property while servicing shorter trips and acting as feeders to the arterials. The roads in local system provide direct access to abutting property for relatively short trips and low volumes at the expense of free-flowing movement. Functional classification is a permanent but evolving representation of a road network. Demand for road access changes with economic growth and increasing prosperity, with relocation of population, economic activities and trade routes, and with expansion of urban areas and concerns for the environment. The functional classification may be updated periodically to take account of changes in transport demands and the road network to fulfill its role as a management tool.

Geometric information of the roadway design can be broken into three main parts: alignment, profile, and cross-section. The combination of the three elements creates a three-dimensional layout for a roadway. The alignment is the route of the road, defined as a series of horizontal tangents and curves. The profile is the vertical aspect of the road, including crest and sag curves, and the straight grade lines connecting them. The cross section shows the position and number of vehicle and bicycle lanes and sidewalks, along with their cross slope or banking. Cross sections also show drainage features, pavement structure and other items outside the category of geometric design. The road capacity data may be determined by the factors mentioned above. The road capacity data may be determined for different kind of intersections, such as free flow (no intersection or intersection where the crossroad stops), signal (intersection controlled by a traffic signal), all stop (the intersection is an all-way stop) and stop sign (the approach has to stop for the crossroad).

Generally, Traffic service providers may report real time traffic speeds, static incidents on a specific road segment and warning messages to drivers driving upstream. The system 102 may be configured to use probe probability values from the probe data that may further help in determining the traffic condition and the dynamic road capacity data. In certain embodiments, the probe probability values may be adjusted using other data such as, road segment attributes the events from the event data such as, but not limited to, weather conditions, in order to take into account the real world variations.

The system 102 may be configured to determine a traffic condition of the at least one lane of the road segment, based on the probe data. The traffic condition may indicate a congestion state or a non-congestion state. The degree of congestion may be classified into different category, such as heavy congestion, moderate congestion (or queueing) or no congestion (or free flow). For example, the traffic condition may be classified into heavy congestion when the value of the congestion lies in between 70%-100%, the traffic condition may be classified into moderate congestion (or queueing) when the value of the congestion lies in between 50%-69% and may be classified into no congestion (or free flow) when the value of the congestion lies in between 1%-49%. The congestion state may hamper drivers, for example by prolonging travel time, by increasing the likelihood of collisions, or by forcing drivers onto unfamiliar or undesirable travel routes.

In accordance with an embodiment, the system 102 may be configured to determine dynamic road capacity data based on the road capacity data, the count of the movable objects, and the traffic condition of the lane of the road segment in the region. The dynamic road capacity data may be determined by the system 102 based on a timestamp. Therefore, to determine the dynamic road capacity data, the system 102 may be configured to calculate a time for the lane of the road segment to reach the congestion state from the non-congestion state. Additionally, the system 102 may be configured to calculate a current deficit of the count of movable objects accommodated in the lane of the road segment to reach the congestion state from the non-congestion state. Therefore, the dynamic road capacity data about road capacity patterns, when transmitted to drivers or autonomous vehicles in a timely manner, may allow drivers or autonomous vehicles to adjust their travel plans to increase safety and convenience.

In accordance with an embodiment, the system 102 may be configured to transmit a report of the dynamic road capacity data to a backend server (not shown in the FIG. 1). Further, in accordance with an embodiment, the system 102 may be configured to update the map data in the map database 108B, based on the dynamic road capacity data. Further, a user of a vehicle (such as the vehicle 118) or the vehicle 118 itself can make an appropriate decision to drive safely, avoid traffic congestion and identify the best route, based on the dynamic road capacity data about road capacity patterns determined by the system 102. In an embodiment, the vehicle 118 may change its maneuver, based on the dynamic road capacity data to drive safely and thereby creating a safer city.

In accordance with an embodiment, the backend server may generate multiple routes including different options for both time, types of lanes, types of road segments, and traffic volume. One route may be limited to only using lanes of road segments that have low volume. Another route may additionally use lanes of road segments that have both low volume and high speed. Each route may also be generated with current or expected traffic conditions based on the dynamic road capacity data to give an estimated time of arrival. The route may be transmitted to the vehicle 118. In accordance with an embodiment, the route may be displayed using a mapping platform 108A.

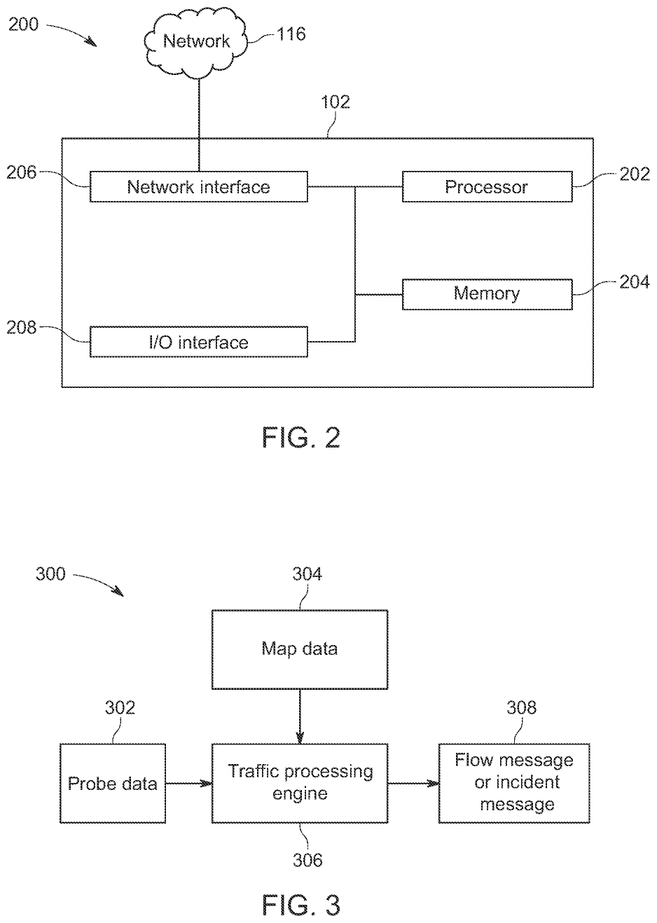

FIG. 2 illustrates a block diagram 200 of the system, exemplarily illustrated in FIG. 1 that may be used for determining road capacity pattern data of a lane of a road segment in a region, in accordance with an example embodiment. FIG. 2 is explained in conjunction with FIG. 1.

In the embodiments described herein, the system 102 may include a processing means, such as, at least one processor (hereinafter interchangeably used with processor) 202, a storage means, such as, at least one memory (hereinafter interchangeably used with memory) 204, a communication means, such as, at least one network interface (hereinafter interchangeably used with network interface) 206 and an I/O interface 208. The processor 202 may retrieve computer executable instructions that may be stored in the memory 204 for execution of the computer executable instructions. The memory 204 may store the probe data and the event data associated with the lane of the road segment in the region for which the dynamic road capacity data may be determined. In accordance with an embodiment, the processor 202 may be configured to obtain input (such as, current probe volume and historical probe volume from the probe data, the road attributes associated with the lane of the road segment in the region) from background batch data services, streaming data services or third party service providers, and renders output, such as, the dynamic road capacity data, the calculated time to reach the congestion state from the non-congestion state and the current deficit of the count of movable objects to reach the congestion state from the non-congestion state, traffic condition notification, etc., for use by the end user on a user device through the network interface 206.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading. Additionally or alternatively, the processor 202 may include one or more processors capable of processing large volumes of workloads and operations to provide support for big data analysis. In an example embodiment, the processor 202 may be in communication with the memory 204 via a bus for passing information among components of the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The network environment, such as, 100 may be accessed using the network interface 206 of the system 102. The network interface 206 may provide an interface for accessing various features and data stored in the system 102.

The processor 202 of the system 102 may be configured to calculate the road capacity data of the lane of the road segment, based on the probe data and one or more map attributes. The processor 202 may be further configured to calculate a count of movable objects in the lane of the road segment, based on the probe data. The processor 202 may be further configured to determine a traffic condition of the lane of the road segment, based on the probe data. The processor 202 may be further configured to calculate incoming lane capacity data and outgoing lane capacity data associated with the road segment based on the probe data and the event data.

The processor 202 may be further configured to generate a traffic pattern profile based on the historical capacity dynamic pattern data, the count of one or more movable objects and the traffic condition of the at least one lane of the road segment. The processor 202 may be configured to store the traffic pattern profile in the memory 204. The processor 202 may be further configured to determine dynamic road capacity data based on the road capacity data, the count of the movable objects, and the traffic condition of the lane of the road segment. The processor 202 may be further configured to calculate a time for the at least one lane of the road segment to reach the congestion state from the non-congestion state. The processor 202 may be further configured to calculate a current deficit of the count of movable objects accommodated in the lane of the road segment to reach the congestion state from the non-congestion state. The calculated time and the current deficit of movable objects accommodated in the lane of the road segment to reach the congestion state from the non-congestion state may correspond to the dynamic road capacity data.

The memory 204 of the system 102 may be configured to store a dataset (such as, but not limited to, the probe data, the event data and the map data) associated with the lane of the road segment in the region. In accordance with an embodiment, the memory 204 may include processing instructions for generating a traffic pattern profile with a dataset associated with the road segment from the event data and the probe data that may be real-time data or historical data, from service providers. The memory 204 of the system 102 may be configured to store the dynamic road capacity data.

In some example embodiments, the I/O interface 208 may communicate with the system 102 and displays input and/or output of the system 102. As such, the I/O interface 208 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 208 circuitry comprising the processor 202 may be configured to control one or more functions of one or more I/O interface 208 elements through computer program instructions (for example, software and/or firmware) stored on a memory 204 accessible to the processor 202. The processor 202 may further render notification associated with the dynamic road capacity data on the user equipment 110 via the I/O interface 208.

In some embodiments, the processor 202 may be configured to provide Internet-of-Things (IoT) related capabilities to users of the system 102 disclosed herein. The IoT related capabilities may in turn be used to provide smart city solutions by providing real time parking updates, big data analysis, and sensor-based data collection by using the cloud based mapping system for providing navigation and parking recommendation services. In some embodiments, the system 102 may be configured to provide an environment for development of parking strategy recommendation solutions for navigation systems in accordance with the embodiments disclosed herein. The environment may be accessed using the network interface 206. The network interface 206 may provide an interface for accessing various features and data stored in the system 102.

FIG. 3 exemplarily illustrates a block diagram 300 of a generic vehicular system to elaborate on problem of congestion state on a road segment, in accordance with an example embodiment. FIG. 3 is explained in conjunction with FIG. 1 and FIG. 2.

With reference to FIG. 3, there are shown blocks in the block diagram 300, viz., probe data 302, map data 304, traffic processing engine 306, and Flow message/incident message 308.

The probe data 302 (also referred as floating car data) may be taken from multiple resources as input to the traffic processing engine 306. The probe data may be a real time probe data that includes sensor data received from mobile devices or probe vehicles, and map artifact data which describes the road segment topology and geometry. The map data 304 may be obtained from map service providers by the traffic processing engine 306. Upon receiving real time probe data, the traffic system engine 306 may ingest the probe data 302 and the map data 304, performs steps such as, but not limited to, map matching and pathing.

Further, the traffic processing engine 306 may deliver flow information or incident messages 308 as output to an end customer (not shown in the FIG. 3) or a service authority. The traffic processing engine 306 may output an estimate of current travel speed for a given road segment (e.g. road link). Based on output speed category, the road condition may be further described as free flow, queueing, and stationary. A traffic congestion queue/jam may occur and start accumulating as a result of traffic volume exceeding the available road capacity. This may be caused by multiple reasons, such as, but not limited to, weather like heavy snow and fog, and sport events. The incident messages 308 may be delivered to an end customer by various communication means, such as, over air radio interface or via internet. Dangerous queuing situations may result in significant crashes or bottlenecks.

Several approaches exist to increase road capacity such by switching the direction of lanes, open/close expressing lanes, and modifying the number of lanes to add extra driving lanes, such as allowing for temporary driving on the road shoulder. However, transportation infrastructure is unable to change significantly. For example, adding more driving lanes seems implausible from economic perspective beyond temporary expansion to the shoulder.

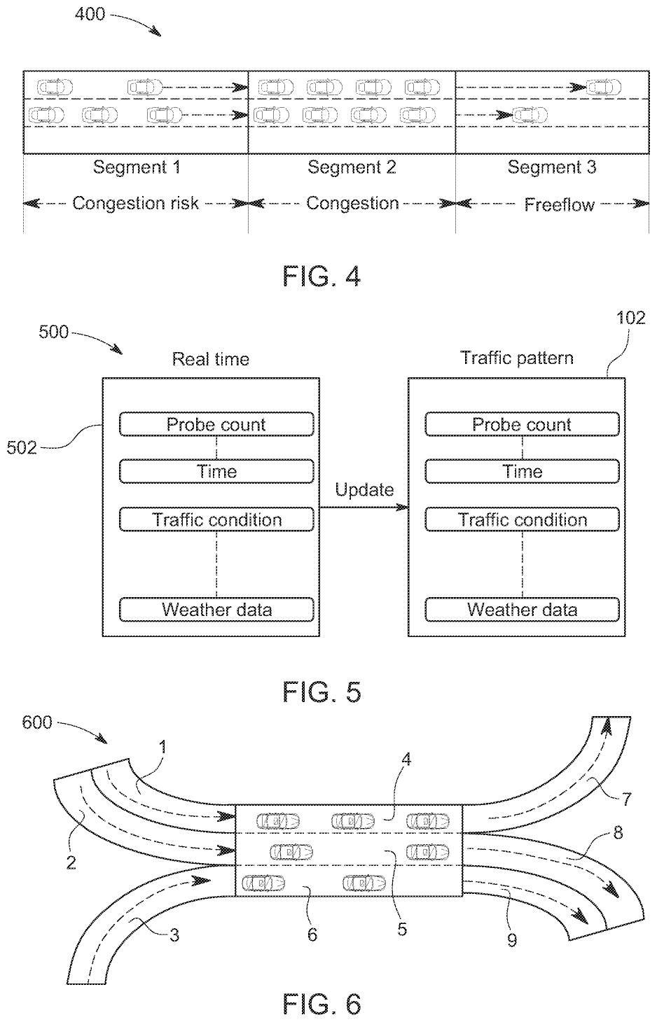

FIG. 4 exemplarily illustrates a schematic diagram 400 for an exemplary scenario used by the system for three road segments with different number of probe vehicles corresponding to different traffic conditions, in accordance with an example embodiment. FIG. 4 is explained in conjunction with FIG. 1 to FIG. 3.

With reference to FIG. 4, there are shown three road segments, viz., segment 1, segment 2 and segment 3. Each of the three road segments has two lanes. A plurality of probe vehicles is moving on each of the three road segments. On segment 1, volume of the probe vehicle may start to increase. However, the volume of probe vehicles has not reached a congestion state. Therefore, the segment 1 may pose congestions risks.

The system 102 may be configured to transmit notification of the congestion risk status in the area or specific road segment. In accordance with an embodiment, the notification of such congestion risk status message can be delivered to an end customer through, such as, but not limited to, RDS messages over the air radio interface, TPEG service by connected HTTP or UDP protocol, DSRC broadcasting data or similar method of low latency communication to the vehicle. In accordance with an embodiment, the system 102 may be configured to control end user vehicle, such as, by enabling or disabling the entering of vehicles into the road segment based on the current or predicted road congestion risk conditions or whether rerouting the upstreaming vehicles or not.

Further, on segment 2, the volume of probe vehicles exceeds the road capacity of the road segment, based on a congestion threshold value. Therefore, on segment 2, the traffic condition reaches a congestion state. From a user perception perspective, driving speed equal to or lower than queueing speed would be considered as a road in a congestion state. A traffic congestion queue/jam may occur and start accumulating as a result of traffic volume exceeding the available road capacity. Congestion may be the result of various root causes, often interacting with one another. Physical Bottlenecks may be a one of the major reasons for the congestion state on the road. The physical bottlenecks may correspond to recurring rush hour traffic where demand may be higher than the amount of traffic that a given highway section can handle. Traffic Incidents like vehicular crashes, breakdowns, and debris in travel lanes are the most common form of incidents that may result in congestion state on the road. Work Zones such as construction activities on the roadway also result in reduced roadway capacity. Weather may be a major cause. The environmental conditions may lead to changes in driver behavior that affect traffic flow. Traffic Control Devices may also excessive delay because of poorly timed flow control systems such as traffic signals. Special Events also shows demand fluctuations that cause surges in traffic demand. Further, there may be fluctuation in normal traffic. The day-to-day variability in demand may leads to some days with higher traffic volumes than others.

Furthermore, on segment 3, the volume of probe vehicle may be far below the congestion threshold value for the road capacity data associated with the road segment. Therefore, on segment 3, the traffic condition may be in free flow state or non-congestion state.

FIG. 5 exemplarily illustrates a schematic diagram 500 for an exemplary scenario to generate a traffic pattern profile corresponding to traffic conditions by a system, in accordance with an example embodiment. FIG. 5 is explained in conjunction with FIG. 1 to FIG. 4.

With reference to FIG. 5, there is shown a system 102 that generates traffic pattern profile for determination of dynamic road capacity data associated with a lane of a road segment in a region. In accordance with an embodiment, the system 102 may be configured to obtain historical capacity dynamic pattern data (or historical probe data) from the probe database 104 for the one or more lanes of the road segment. The system 102 may store historical capacity dynamic pattern data that indicates a history of traffic pattern associated with congestion information for the region in the memory 202.

In accordance with an embodiment, the historical probe data may include travel time, delay time, speed, and congestion data for various times of the day, days of the week, days of the year, and so on. The historical probe data may be used by the system 102 to predict clearance time for a traffic event, to predict traffic conditions when the probe data, and/or incident data is unavailable for a particular roadway, to predict a probability of accidents; or for any other suitable purpose. For example, accidents may be more likely when speeds are variable at certain times of the day. These types of statistics may be determined by analyzing the historical probe data by the system 102.

The system 102 may be further configured to obtain real-time or near real-time probe data from the probe database 104. Accordingly, the real time probe data may be obtained by a system 502, which may be similar in its structure and functions to the system 102. Further the system 502 may be used to update the data stored in the system 102 based on real-times or near real-time information, as and when probe data is gathered. The probe data may include both historical and real time probe data. The term “real-time” as used throughout the disclosure may denote that collected data may be delivered to the system 102 in a timely manner with delays as need to transfer the data from a data collection point to the system 102.

The probe data may include a probe count (or count of one or more movable objects) calculated for a given time period (or time) and the traffic condition of the lane of the road segment. The traffic condition may also depend on special events like weather (heavy rains, snow or fog) and sports event. The traffic condition may indicate a congestion state or a non-congestion state. The system 102 may be configured to determine the probe data distribution of the count of movable objects on the lane on the road segment based on the change in traffic condition from the non-congestion state to the congestion state.

In accordance with an embodiment, data such as, but not limited to, the historical probe data and the event data for weather may be updated at a less frequent rate. For example, the historical probe data and the event data may be updated as part of a routine update, such as a weekly update. In accordance with an embodiment, the system 102 may be configured to generate the traffic pattern profile based on the historical probe data and the real time (or near real time) probe data. The system 102 may be configured to determine the dynamic road capacity data for the lane of the road segment, based on the generated traffic pattern profile.

FIG. 6 exemplarily illustrates a schematic diagram 600 for an exemplary scenario to determine, by a system, dynamic road capacity data corresponding to traffic conditions using upstreaming road segment and down streaming road segment on a lane level capacity connection, in accordance with an example embodiment. FIG. 6 is explained in conjunction with FIG. 1 to FIG. 5.

With reference to FIG. 6, there are shown 9 lanes, viz., lane 1 to lane 9 that are represented by numerals 1 to 9 respectively. There is shown a rectangular road segment that includes lane 4 to lane 6. Lane 1 to lane 3 may be included in an upstreaming road segment to the rectangular road segment. Lane 7 to lane 9 may be included in a downstreaming road segment to the rectangular road segment. In accordance with an embodiment, the system 102 may be configured to determine the dynamic road capacity data for the lane 4 of the rectangular road segment. There is further shown a plurality of vehicles on the rectangular road segment with lanes 4 to 6.

In accordance with an embodiment, the system 102 may be configured to calculate incoming lane capacity data for lanes 1 to 3 and outgoing lane capacity data for lanes 7 to 9 for determination of the dynamic road capacity data on the lane 4 of the rectangular road segment based on the probe data and the event data. The system 102 takes into account the incoming lane capacity data for lanes 1 to 3 and outgoing lane capacity data for lanes 7 to 9 so as to make a passable strategy for the vehicles on the rectangular road segment. For example, when the lane 4 poses a congestion risk status, then the vehicles on the lane 1 may be diverted to lane 5 and further to lane 8 to avoid congestion risk.

In accordance with an embodiment, the system 102 may be configured to calculate a time for the lane 4 of the rectangular road segment to reach the congestion state from the non-congestion state. The time may be calculated as:

$$t = \frac{n - m}{x - y}$$

wherein t is time taken for the one or more movable objects to reach the congestion state from the non-congestion state,
wherein n is congestion capacity threshold for the at least one lane of the road segment,
wherein m is current count of one or more movable objects on the at least one lane of the road segment,
wherein n>m;
wherein x is incoming count of one or more movable objects on the at least one lane of the road segment per certain time period, and
wherein y is outgoing count of one or more movable objects on the at least one lane of the road segment per certain time period.

In accordance with another embodiment, the formula to calculate time t may be applied for multiple incoming road segments and multiple outgoing road segments. In accordance with an embodiment, the system 102 may be configured to calculate a current deficit of the vehicles accommodated in the lane 4 of the rectangular road segment to reach the congestion state from the non-congestion state. In accordance with an embodiment, the calculated time and the current deficit of the count of one or more movable objects accommodated in the at least one lane of the road segment to reach the congestion state from the non-congestion state may be indicated by the dynamic road capacity data for the lane 4 of the rectangular segment.

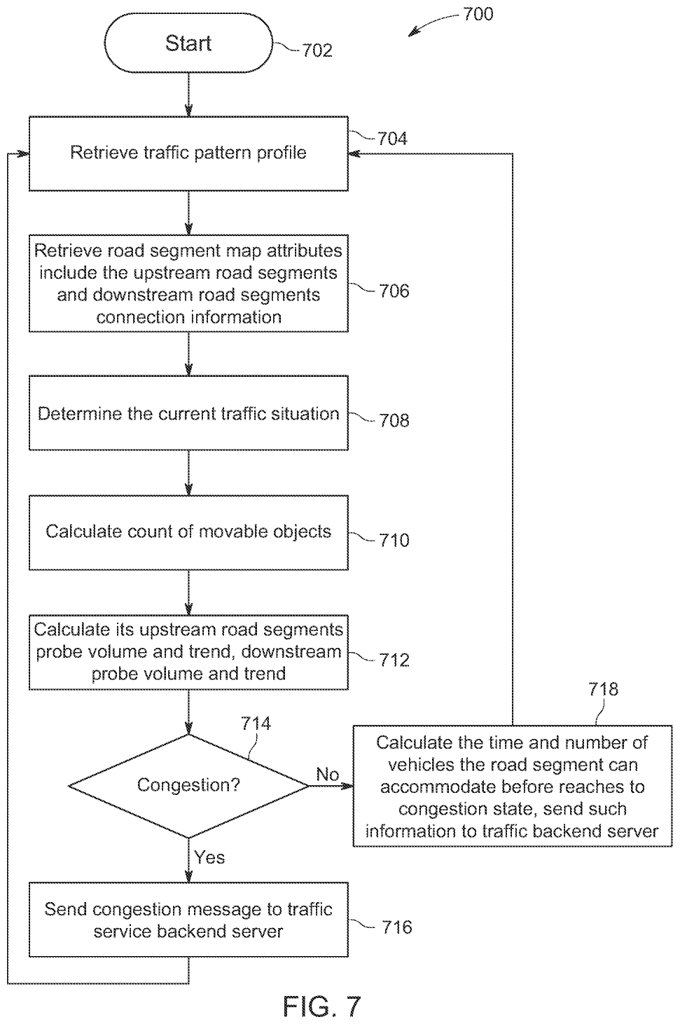

FIG. 7 illustrates a flowchart 700 for implementation of an exemplary method to calculate dynamic road capacity data of a lane of a road segment in a region, in accordance with an example embodiment. The method starts at 702.

At 704, traffic pattern profile of the lane of the one or more road segments may be retrieved from a database of the system 102. The processor 202 may be configured to retrieve the traffic pattern profile of the lane of the road segment. The generation of the traffic pattern profile by the system 102 is explained in detail in FIG. 5

At 706, road segment map attributes that includes upstream road segment and downstream road segment connection data may be retrieved. The processor 202 may be configured to retrieve the road segment map attributes that includes upstream road segment and downstream road segment connection data of the region.

At 708, traffic condition of the lane of the road segment may be determined. The processor 202 may be configured to determine the traffic condition of the lane of the road segment. The traffic conditions on the road segment are explained in FIG. 1.

At 710, count of one or more movable objects on the lane of the road segment may be calculated. The processor 202 may be configured to calculate the count of one or more movable objects on the lane of the road segment. The count of one or more movable objects on the lane of the road segment may be calculated in real time.

At 712, upstream road segment probe volume and downstream probe volume may be calculated. The processor 202 may be configured to calculate the upstream road segment probe volume and the downstream probe volume. Probe volume may correspond to the count of the movable objects for a given time interval.

At 714, it may be tested whether the lane of the road segment is congested or not. The control moves to 718 for non-congestion state else 716 for congestion state. The processor 202 may be configured to test whether the lane of the road segment is congested or not. The traffic condition on the lane of the road segment may correspond to a congestion state or a non-congestion state.

At 716, congestion message to the traffic service backend server may be sent. The processor 202 may be configured to send the congestion message to the traffic service backend server. Map data in the map database 108B may be updated based on the congestion message sent to the traffic service backend server.

At 718, when the lane of the road segment is not congested estimate (or calculate) the time and a number of vehicles, the road segment can accommodate before reaching the congestion state and send such information to a traffic backend server. The processor 202 may be configured to calculate the time and a number of vehicles; the road segment can accommodate before reaching the congestion state and send such information to a traffic backend server. Data for the calculated time and number of vehicles, the road segment can accommodate before reaching the congestion state may correspond to dynamic road capacity data for the lane of the road segment. The control passes to 704.

Accordingly, blocks of the flowchart 700 support combinations of means for performing the specified functions and combinations of operations for performing the specified functions for performing the specified functions. It will also be understood that one or more blocks of the flowchart 700, and combinations of blocks in the flowchart 700, can be implemented by special purpose hardware-based computer systems which perform the specified functions, or combinations of special purpose hardware and computer instructions.

Alternatively, the system may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the method 700 disclosed herein, the end result generated by the system 102 is a tangible determination of dynamic road capacity data for each lane of plurality of lanes on a road segment. The determination of the dynamic road capacity data is of utmost importance to avoid mishaps from happening on roads, busy streets, highways, freeways, etc. In case of testing and deployment of autonomous vehicles, the determination of the dynamic road capacity data on a vehicle may be used to study the behavior of the autonomous vehicles and effects of collisions on the structure of the autonomous vehicle.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for determining dynamic road capacity data, the system comprising:
at least one non-transitory memory configured to store computer executable instructions; and
at least one processor configured to execute the computer executable instructions to:
obtain a set of input data comprising at least probe data, historical capacity dynamic pattern data associated with at least one lane of a road segment;
calculate road capacity data of the at least one lane of the road segment, based on the probe data and one or more map attributes;
calculate a count of one or more movable objects in the at least one lane of the road segment, based on the probe data;
determine a traffic condition of the at least one lane of the road segment, based on the probe data; and
determine dynamic road capacity data based on the road capacity data, the count of the one or more movable objects, the historical capacity dynamic pattern data, and the traffic condition of the at least one lane of the road segment.

2. The system of claim 1, wherein the traffic condition indicates a congestion state or a non-congestion state.

3. The system of claim 2, wherein to determine the dynamic road capacity data, the at least one processor is further configured to calculate a time for the at least one lane of the road segment to reach the congestion state from the non-congestion state.

4. The system of claim 3, wherein the time is calculated as:
$$t = \frac{n - m}{x - y}$$
wherein t is the time taken for the one or more movable objects to reach the congestion state from the non-congestion state,
wherein n is congestion capacity threshold for the at least one lane of the road segment,
wherein m is current count of one or more movable objects on the at least one lane of the road segment,
wherein n >=m;
wherein x is incoming count of one or more movable objects on the at least one lane of the road segment per certain time period, and
wherein y is outgoing count of one or more movable objects on the at least one lane of the road segment per certain time period.

5. The system of claim 4, wherein to determine the dynamic road capacity data, the at least one processor is further configured to calculate a current deficit of the count of one or more movable objects accommodated in the at least one lane of the road segment to reach the congestion state from the non-congestion state.

6. The system of claim 1, wherein the at least one processor is further configured to:
obtain event data associated with the at least one lane of the road segment of the region; and
calculate incoming lane capacity data and outgoing lane capacity data associated with the road segment based on the probe data and the event data.

7. The system of claim 6, wherein the event data comprises weather data, holiday data, and music festivals data.

8. The system of claim 7, wherein the determined traffic condition is further based on the event data.

9. The system of claim 1, wherein to determine the dynamic road capacity data, the at least one processor is further configured to:
retrieve the historical capacity dynamic pattern data for the at least one lane of the road segment;
generate a traffic pattern profile based on the historical capacity dynamic pattern data, the count of one or more movable objects and the traffic condition of the at least one lane of the road segment.

10. The system of claim 1, wherein to determine a traffic condition of the at least one road segment, the at least one processor is further configured to calculate a ratio between the count of the one or more movable objects and the road capacity.

11. The system of claim 1, wherein the at least one processor is further configured to transmit a report of the dynamic road capacity data to a backend server.

12. The system of claim 11, wherein the at least one processor is further configured to:
obtain map data of the region; and
update the map data of the region based on the report of the dynamic road capacity data.

13. The system of claim 12, wherein the at least one processor is further configured to transmit congestion risk warning message to one or more end user vehicles in the at least one road segment based on the updated map data.

14. The system of claim 12, wherein the at least one processor is further configured to recommend driving strategies to one or more vehicles driving upstream of the at least one lane of the road segment based on the updated map data.

15. The system of claim 1, wherein the map attributes include upstream road segment data for an upstream road segment connected to the at least one road segment and downstream road segment data for a downstream road segment connected to the at least one road segment.

16. The system of claim 1, wherein the at least one processor is further configured to map match the probe data to the at least one lane of the road segment.

17. A method for determining dynamic road capacity data, the method comprising:
obtaining, by one or more processors, a set of input data comprising at least probe data and historical capacity dynamic pattern data associated with at least one lane of a road segment;
calculating, by one or more processors, a road capacity data of the at least one lane of the road segment, based on the probe data and one or more map attributes;
calculating, by one or more processors, a count of one or more movable objects in the at least one lane of the road segment, based on the probe data;
determining, by one or more processors, a traffic condition of the at least one lane of the road segment, based on the probe data; and
determining, by one or more processors, the dynamic road capacity data based on the road capacity data, the count of the one or more movable objects, the historical capacity dynamic pattern data and the traffic condition of the at least one lane of the road segment.

18. The method of claim 17, wherein to determine the dynamic road capacity data, calculating a time for the at least one lane of the road segment to reach the congestion state from the non-congestion state.

19. The method of claim 17, to determine the dynamic road capacity data, calculating a current deficit of the count of one or more movable objects accommodated in the at least one lane of the road segment to reach the congestion state from the non-congestion state.

20. A computer programmable product comprising a non-transitory computer readable medium having stored thereon computer executable instructions, which when executed by one or more processors, cause the one or more processors to carry out operations for determining dynamic road capacity data, the operations comprising:
obtaining, by one or more processors, a set of input data comprising at least probe data and historical capacity dynamic pattern data associated with at least one lane of a road segment;
calculating, by one or more processors, a road capacity data of the at least one lane of the road segment, based on the probe data and one or more map attributes;
calculating, by one or more processors, a count of one or more movable objects in the at least one lane of the road segment, based on the probe data;
determining, by one or more processors, a traffic condition of the at least one lane of the road segment, based on the probe data; and
determining, by one or more processors, the dynamic road capacity data based on the road capacity data, the count of the one or more movable objects, the historical capacity dynamic pattern data and the traffic condition of the at least one lane of the road segment.
